(19) United States
(12) Patent Application Publication
(10) Pub. No.: US 2005/0160423 A1
(43) Pub. Date: Jul. 21, 2005

(54) Enabling a guest virtual machine in a windows environment for policy-based participation in grid computations

(76) Inventors: David Frederick Bantz, Bedford Hills, NY (US); Vijay K. Naik, Pleasantville, NY (US); Swaminathan Sivasubramanian, Amstelveen (NL)

Correspondence Address: Thomas A. Beck Esq., 26 Rockledge Lane, New Milford, CT, 06776, US

(21) Appl. No.: 10/320,315

(22) Filed: Dec. 16, 2002

(51) Int. Cl. G06F 9/455

(52) U.S. Cl. 718/1

(57) ABSTRACT

The invention introduces new software components into a host-agent interactive workstation such as a personal computer. The new software components, in combination, monitor and model the interactive usage of the aforementioned interactive workstation. A first software component communicates with a second software component which is a policy-based decision-making component which runs on a guest operating system that resides in a virtual machine, and together they implement policies that concern the behavior of grid computations in the presence of the interactive usage of the workstation.

### BACKGROUND OF THE INVENTION

1. Field of the Invention

The present invention relates generally to the field of grid computations and the means of dealing with the conditions and policies that control the operation of same.

More particularly, the invention comprises a system comprising software that runs on a personal computer which consists of a host-agent, which runs as an application on a host operating system and it consists of a policy-based decision-making component which runs on a guest operating system in a virtual machine.

2. Description of the Prior Art

Personal computers represent the majority of the computing resources of the average enterprise. These resources are not utilized all of the time. The present invention recognizes this fact and permits utilization of computing resources through grid-based computation running on virtual machines, which in turn can easily be run on each personal computer in the enterprise.

Grid computing, a scheme for managing distributed resources for the purposes of allocation to a parallelizable computation, is both a topic of current research and an active business opportunity.

The fundamentals of grid computing are described in The Grid: Blueprint for a New Computing Infrastructure, I. Foster, C. Kesselman, (eds.), Morgan Kaufmann, 1999. The authors wrote: “A computational grid is a hardware and software infrastructure that provides dependable, consistent, pervasive, and inexpensive access to high-end computational capabilities.”

For many years it has been recognized that the computational resource of interactive workstations is a possible target for grid computations. Examples of resources that can be shared with grid computations include laptop PCs, desktop PCs and interactive workstations, backend servers and web servers. Desktop PCs and interactive workstations are deployed for running interactive applications on behalf of a single user. (For the purposes of the description of the present invention, as used herein, the terms “laptop PCs,” “desktop system,” “desktop PC” and “interactive workstation” are used interchangeably.

One estimate has nearly 75% of the computational resource available to an organization represented by its interactive workstations. Although the use of interactive workstations as hosts for grid computations is not new (see: “Condor—A Hunter of Idle Workstations,” Michael Litzkow, Miron Livny, and Matt Mutka, in Proc. 8th International Conference of Distributed Computing Systems, pp. 104-111, June, 1988), this use has not been widely adopted in general, and not in the specific manner described in the present invention.

The Condor system runs grid computations on the one and only operating system of the workstation, providing only that protection between interactive and grid computations as is afforded by the operating system. While workstation operating systems exist that are capable of providing some protection between these computations, the most widely deployed workstation operating system, e.g., Windows, provides such limited protection that in many cases of interest, both computations are exposed to functional interference from the other.

There are several reasons for the lack of adoption of the use of interactive work stations as hosts for grid computations:
Interactive workstations have been economically justified based on their value to their end users. That value is compromised when interaction responsiveness is degraded. Existing solutions for running grid computations on interactive workstations do not sufficiently protect the responsiveness of their interactive computations.
Similarly, it is important to protect both the interactive computations and the grid computations from affecting each other's correctness.
A given grid computation may have been implemented in such a way as to depend on the functions and facilities of a particular operating system. Similarly, a given interactive computation may have been implemented in such a way as to depend on the functions and facilities of a different operating system. It is important to allow the operating system for grid computations to be chosen independently from the operating system for interactive computations.

The Condor system, noted above, runs grid computations on the one and only operating system of the workstation, providing only that protection between interactive and grid computations that is afforded by the operating system. While workstation operating systems exist that are capable of providing some protection between these computations, the most widely deployed workstation operating system, Windows, provides such limited protection that in many cases of interest, both computations are exposed to functional interference from the other.

What is needed is the combination of two mechanisms: one which isolates the interactive computation from the grid computation, and the other which monitors the needs for interactive computation and throttles the grid computation to maintain interactive responsiveness. In fact, this latter mechanism permits continued responsiveness, but it may be desirable for the organization owning the interactive workstations to compromise that responsiveness selectively, in accordance with one or more organizational policies.

The present invention is an improvement over the Condor system in that the present invention isolates applications which Condor does not. Condor does not use a hypervisor supported virtual machine whereas the present invention, as will be discussed in greater detail hereinafter, isolates applications in the virtual machine from those that are directly supported by a host operating system in an interactive workstation. This provides protection to both workstation users as well as grid users.

In Condor, grid workload runs directly on top of the host operating system and thus the Condor system has no isolation. Besides not providing isolation, under normal operating conditions, this lack of isolation in the Condor system imposes limitations on how quickly grid applications can be suspended or checkpointed without modifying the operating system and/or the grid applications.

Condor has monitoring entities, but no entity to control the entire state of the grid workload since part of that state in Condor is in the host operating system.

In accordance with the present invention, using a hypervisor and a virtual machine support, the responsiveness of the system is much faster than the resposniveness of Condor's system. This requires no changes to the host operating system or the grid applications.

The present invention is a significant enabler for e-Business on Demand, because it makes resources available for the remote provision of services that are not currently available. The present invention makes a model possible where e-Business on Demand is provisioned from the customer's interactive workstations, a significant cost reduction for the service provider.

### SUMMARY OF THE INVENTION

The invention disclosed herein exploits the properties of guest-host hypervisors, which support virtual machines, to isolate interactive computations performed by applications using the host operating system from grid computations performed by applications using a guest operating system in the virtual machine.

Desktop virtual machines support the Linux operating system, among other Unix derivatives, on which most grid computations are built. They represent an independently schedulable process whose priority can be controlled by the PC operating system. The desktop virtual machines protect grid computations from interference from non-grid computations and vice-versa. The desktop virtual machines also have advantages in the deployment of grid computations.

A current example of a guest-host hypervisor is VMWare Workstation, offered by VMWare Inc. of 3145 Porter Drive, Palo Alto, Calif. “Hypervisors” are described in the paper “Summary of Virtual Machines Research,” by R. P. Goldberg, IEEE Computer Magazine, 7(6), pp. 34-45, 1974, the contents of which are incorporated by reference herein.

The present invention introduces new software components into the interactive workstation. The new software components, in combination, monitor and model the interactive usage of the interactive work station. A first software component communicates with a second software component that resides in the virtual machine and together they implement policies that concern the behavior of grid computations in the presence of the interactive usage of the workstation.

The value of this invention to the end user is that if policy so provides, the interactive responsiveness of his or her workstation will be unaffected by any computational workload imposed on that workstation as a result of grid computations.

Further, the interactive computations performed on behalf of the end user will be protected from any functional interference due to the execution of grid computations. The value of this invention to the organization that owns the workstation is that the unutilized computational resources of the workstation will now be available for computations of concern to the organization. These computations will be protected from any functional interference due to the execution of interactive computations on that workstation.

The additional software elements embodied in the system of the present invention such as the host agent and the virtual machine manage (VMM) provide the necessary monitoring and controlling mechanisms to enforce the policies defined by workstation users with a higher degree of responsiveness and precision than available in the prior art.

The present invention: (1) provides isolation to interactive workload and grid workload and (2) assures workstation users that they can set their own policies to control the exact manner in which their desktop/workstation resources are to be utilized. A similar invention to the present invention relates to “Policy-Based Hierarchical Management of Shared Resources in a Grid Environment” and is disclosed in copending application Ser. No. ______, filed concurrently with the instant invention, the contents of which are hereby incorporated by reference herein. That invention discloses dampening the effects of changes in the availability of workstation resources on grid computations through predictions, aggregation and provisioning of excess resources.

### BRIEF DESCRIPTION OF THE DRAWINGS

The present invention will be more fully understood by reference to the following detailed description of the preferred embodiment of the present invention when read in conjunction with the accompanying drawings, in which reference characters refer to like parts throughout the views and in which:

FIG. 1 is a block diagram of a system including the invention.

FIG. 2 is an expanded detailed view of the interactive workstation depicted in FIG. 1.

FIG. 3 is an expanded detailed view of the Host Agent included in FIG. 1.

FIG. 4a is an example of an inter-component communications software function.

FIG. 4b is an example of the monitoring framework software function.

FIG. 5 is a more detailed depiction of the policy-based decisions making component.

FIG. 6 is an example of a workload model used to predict the resource availability information.

FIG. 7 lists typical policy rules.

### DESCRIPTION OF THE PREFERRED EMBODIMENTS

The present invention comprises software that runs on a personal computer. Optionally, it comprises software that runs on server computers in a computer network.

The software of the present invention that runs on a personal computer, as mentioned above, consists of two components. The first is a host-agent component, which runs as an application on a host operating system, and the second is a policy-based decision-making component, which runs on a guest operating system in a virtual machine.

The host agent monitors the usage of the resources of the workstation, categorizing that usage into interactive use and grid computation usage. The host-agent communicates a sequence of usage measurements to the policy-based decision-making component, which does a time series analysis of the usage measurements. This analysis is used to update a model of the resource availability of the workstation for grid computations. The model is used to determine the suitability of the workstation for future grid computations, and whether to defer any current grid computations to prevent a reduction in the interactive responsiveness of the workstation.

If it is determined that the workstation is currently being used interactively, or if it is likely to be used interactively in the near future, a remote grid manager is notified. The grid manager will then not allocate any new grid computations to that workstation. If the workstation is currently performing grid computations and interactive use commences, the grid computation will be run at low priority until it can be checkpointed and either deferred or migrated to another virtual machine in another workstation.

The preferred embodiment of the present invention is defined in the following description of the method employed, and the apparatus necessary to implement said method:

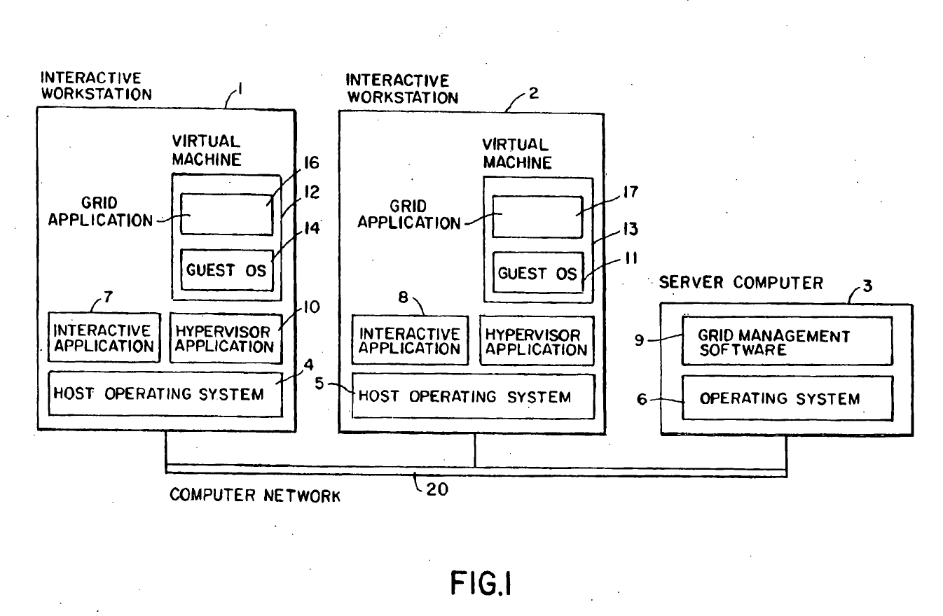

FIG. 1 shows an overall block diagram of the system including the particular elements that comprise the present invention. The system block diagram comprises computer network 20 comprising interactive workstations 1 and 2 and server computer 3.

In FIG. 1, two interactive workstations 1 and 2 are shown attached to and capable of communicating to computer network 20. Each of these two interactive workstations contains a host operating system 4 and 5 supporting interactive applications 7 and 8. Both interactive workstations 1 and 2 also contain hypervisor applications 10 and 11, supported by host operating systems 4 and 5. Each hypervisor application 10 and 11 supports a virtual machine 12 and 13. Each virtual machine contains a guest operating system 14 and 15, which supports grid applications 16 and 17.

Also shown in FIG. 1, is a server computer 3 with operating system 6 and grid management software 9. Server computer 3 is attached to computer network 20 and is capable of communicating with it. Interactive workstations 1 and 2 can communicate with server computer 3 via computer network 20. Hosts OS 4 and OS 5 and server OS 6 contain communications function permitting applications using host OS 4 and OS 5 and server OS 6 to communicate. Guest OS 14 and 15 contain communications function permitting applications using guest OS 14 and 15 to communicate with host OS 4 and 5. In this manner it can be seen that grid applications 16 and 17 can communicate with grid management software 9.

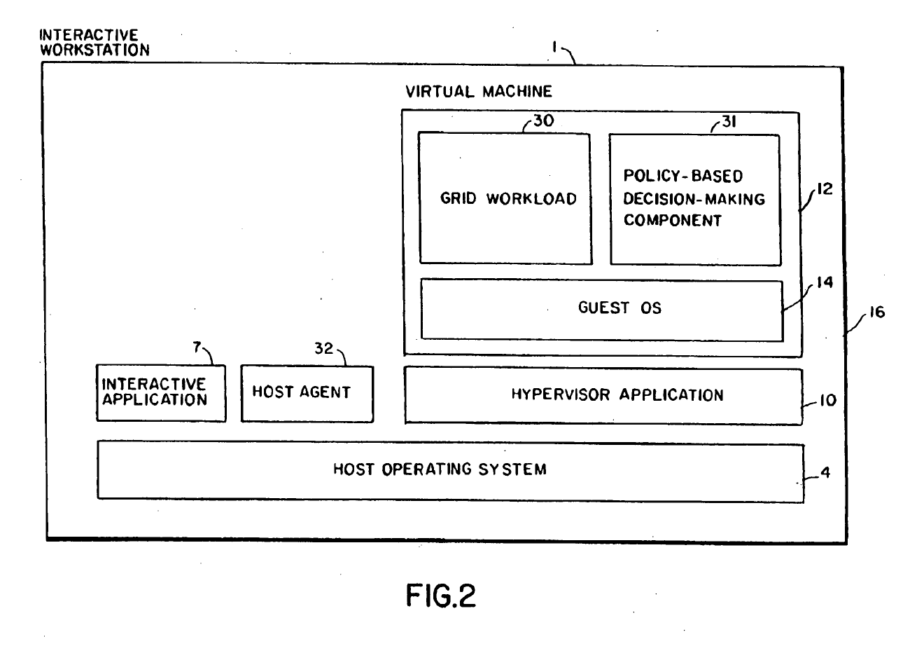

FIG. 2 is an expanded view of interactive workstation 1 showing additional software components including host agent 32, grid workload 30 and policy-based decision-making component 31. It can be seen from FIG. 2 that host-agent 32 is an application program using the functions and facilities of host operating system 4, while both grid workload 30 and policy-based decision-making component 31 are application programs using the functions and facilities of guest operating system 14. Guest operating system 14, grid workload 30 and policy-based decision-making component 31 all run in virtual machine 12, which is supported by hypervisor application 10.

As previously noted, guest operating system 14 and host operating system 4 contain communications functions permitting applications using guest operating system 14 and host operating system 4 to communicate generally. In this manner it can be seen that policy-based decision-making component 31 can communicate with host agent 32.

As will be described subsequently, host-agent 32 uses the functions and facilities of host operating system 4 to obtain information about the current state of resource utilization of all software components supported by host operating system 4, and because host agent 32 can communicate with policy-based decision-making component 31, it can pass this resource utilization information to policy-based decision-making component 31. Policy-based decision-making component 31 will analyze this information and use it to update a model of resource utilization. This model will be used in subsequent resource allocation decisions. Host-agent 32 can obtain information about the current state of resource utilization of all software components using, for example, the Windows Management Information (hereinafter “WMI”) application programming interface (API), supported by Microsoft Windows 2000 Professional and Microsoft Windows XP Professional operating systems for interactive workstations. Information about the WMI APIs is presently available from the Web page at http://msdn.microsoft.com/library/default.asp?url=/library/en-us/wmisdk/wmi/wmi_start_page.asp.

In the preferred embodiment of the present invention, host agent 32 of FIG. 2 is limited to monitoring functions, with analysis functions being performed in the policy-based decision-making component 31 of FIG. 2. This is advantageous because a situation may arise that a given interactive workstation 1 could support multiple hypervisor applications 10, permitting its membership in multiple grids, it or could support multiple virtual machines 12, also permitting its membership in multiple grids.

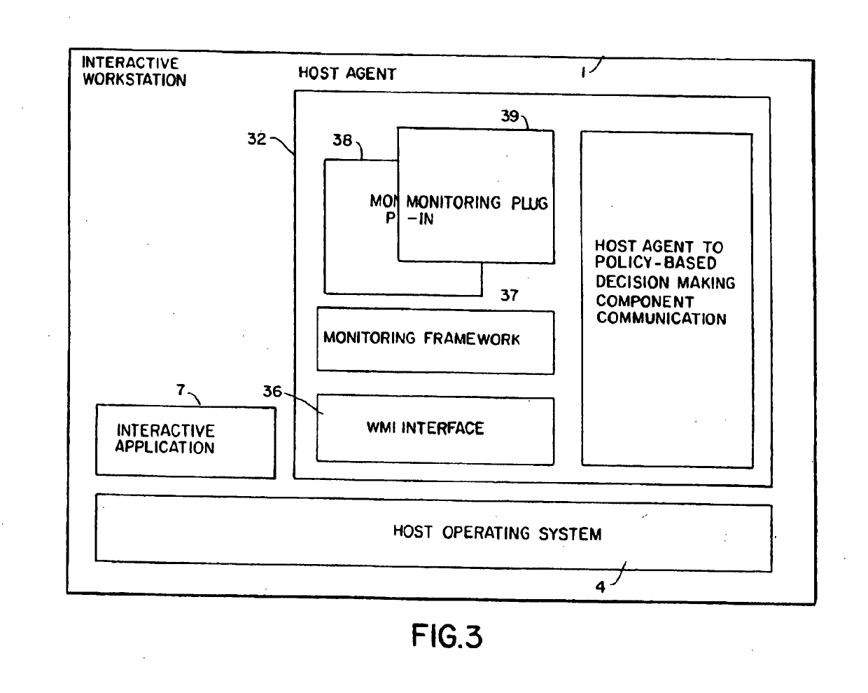

FIG. 3 provides additional detail as to the software structure of host agent 32. FIG. 3 clearly depicts that host agent 32 comprises WMI interface 36, monitoring framework 37, one or more monitoring plug-ins 38 and 39, and inter-component communications software 35. The purpose of inter-component communications software 35 is to simplify the implementation of monitoring plug-ins 38 and 39 by providing just the communications functions needed by these plug-ins.

FIG. 3 also shows monitoring framework 37 whose purpose, together with that of WMI interface 36, is to simplify the implementation of monitoring plug-ins 38 and 39 by providing just the functions required to retrieve resource utilization information from the WMI APIs, and by providing functions supporting the downloading of new monitoring plug-ins, registering those plug-ins with the monitoring framework 37, and activating and de-activating plug-ins. Monitoring plug-ins may be downloaded via the inter-component communications software 35.

Alternatively, commands may be sent from the policy-based decision-making component 31 shown in FIG. 2, to monitoring framework 37 to cause monitoring framework 37 to download plug-ins using the functions and facilities of host operating system 4.

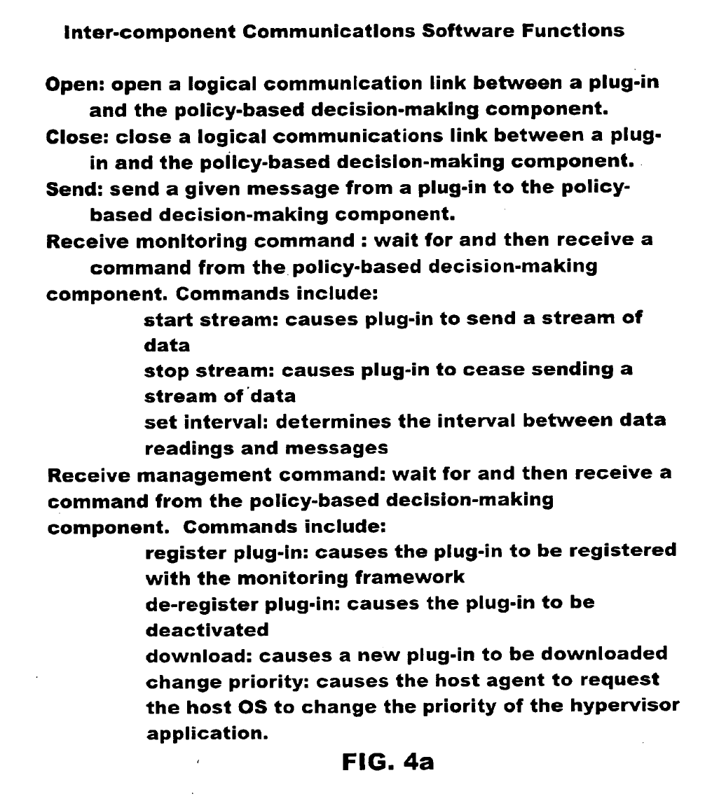

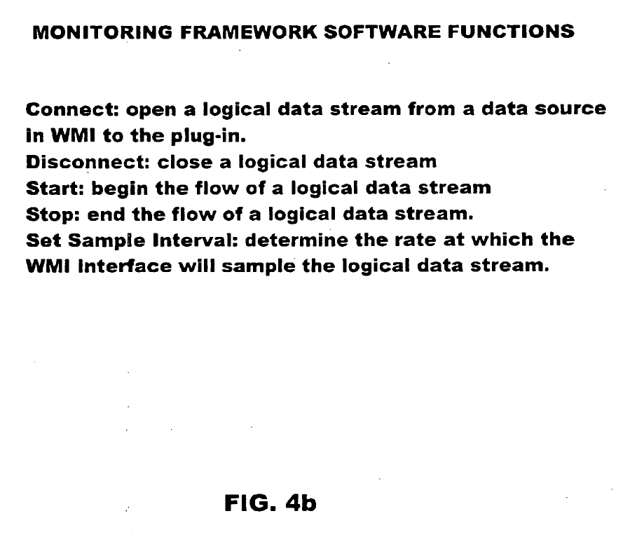

FIGS. 4a and 4b list, in exemplary manner, typical functions supported by inter-component communications software 35 and monitoring framework 37. Implementation of these functions will be familiar to those skilled in the programming art.

FIG. 4a lists functions supported by the inter-component communications software. Of special note are the “Receive monitoring” command and “Receive management” command functions.

The Receive monitoring command causes the plug-in to wait for a command from the policy-based decision-making component 31 of FIG. 2. Commands manage and parameterize streams of resource utilization readings.

The Receive management command functions download and manage plug-ins and interact with the host OS 4 of FIG. 3.

In particular, the change priority command causes the inter-component communications software 35 to request that the host operating system 4 change the scheduling priority of the hypervisor application 10 of FIG. 2. The monitoring framework 37 of FIG. 3, as opposed to plug-ins, typically invokes this function.

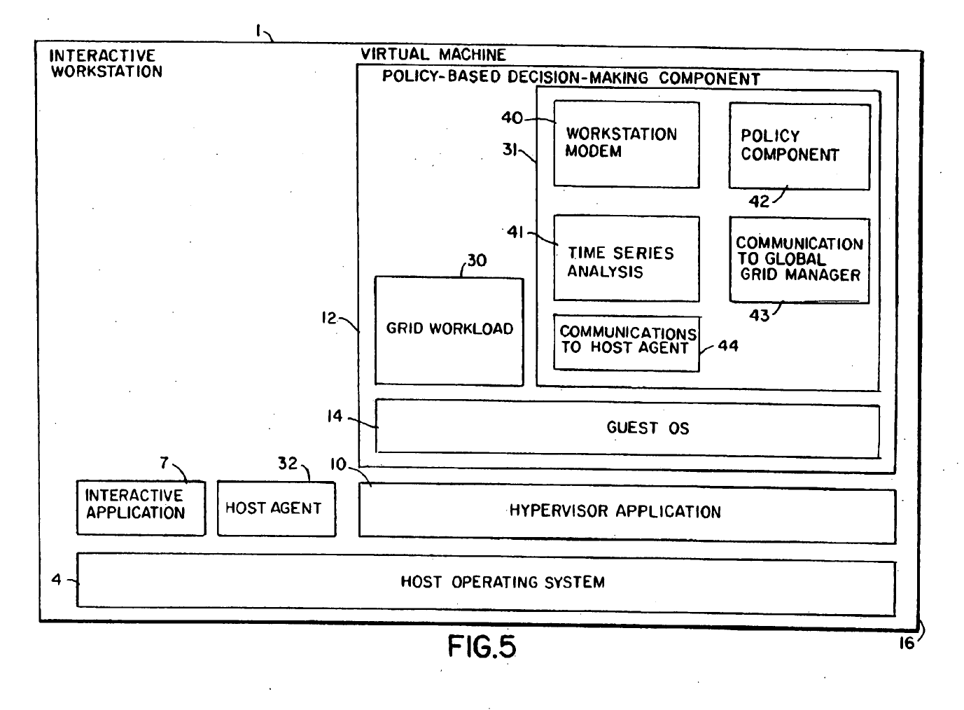

FIG. 5 provides additional detail as to the software structure of the policy-based decision-making component 31. The policy-based decision-making component 31 comprises workstation model 40, time series analysis 41, policy component 42, communication component to global grid manager 43 and communication component to host agent 44.

Time series analysis 41 receives samples of resource utilization via communications component to host agent 44 and performs statistical analyses of the sequence of samples so as to eliminate short-term variations and identify longer-term variations. By way of illustration, “time series analysis” is described in the book Time Series Analysis, by James D. Hamilton, Princeton University Press, 1994, the contents of which are hereby incorporated by reference herein.

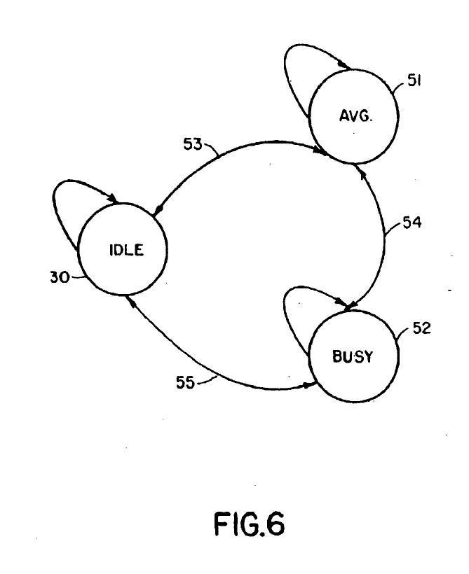

The results of time series analysis 41 are used to update workstation model 40. Workstation model 40 is preferably implemented as a software object with three states, as shown in FIG. 6.

States 50, 51 and 52 in FIG. 6 represent the status of resource utilization of interactive workstation 1 in FIG. 2. State 50, the IDLE state, represents minimal resource utilization of interactive workstation 1 in FIG. 2. Such resource utilization is due to processing of all host OS applications 7 of FIG. 2 other than the hypervisor application 10 of FIG. 2 and the host agent 32 of FIG. 2. State 51 of FIG. 6 represents an intermediate state of resource utilization of interactive workstation 1 of FIG. 2, due to the varying nature of interactive workload. That is, state 51 represents the situation in which an interactive workload has been present in the recent past but may or may not be present currently. State 52 of FIG. 6 represents a high state of resource utilization of interactive workstation 1 in FIG. 2. That is, state 52 represents the situation in which an interactive workload is currently present and significantly utilizes the resources of interactive workstation 1 of FIG. 2.

In FIG. 6, state transition 53 represents the onset or ceasing of an interactive workload in interactive workstation 1 of FIG. 2. State transition 54 represents the onset or ceasing of a burst of intense interactive activity, while state transition 55 represents the ceasing or resumption of interactive activity as a whole.

Notice of state transitions of workstation model 40 of FIG. 5 is passed to policy component 42 which acts according to policies set by either the user of the interactive workstation or by administrators of the interactive workstation or both. Preferably, policy component 42 of FIG. 5 is implemented as a rules-driven engine. Rules-driven engines are described in the book Artificial Intelligence A Modern Approach, by Stuart Russell and Peter Norvig, published by Prentice Hall in 1995, the contents of which are hereby incorporated by reference herein.

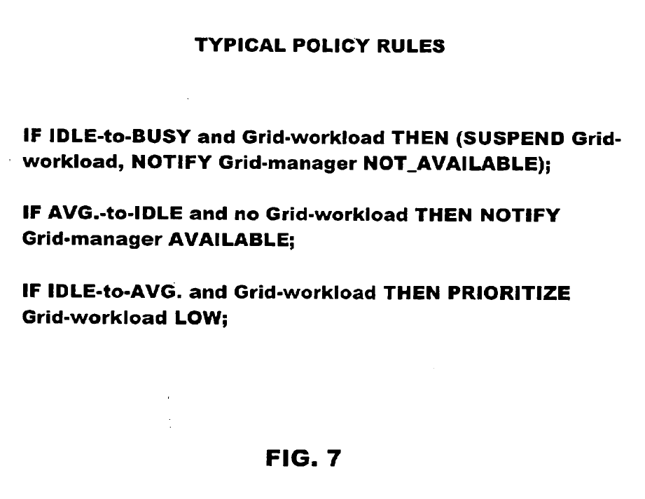

FIG. 7 presents an exemplary sample of typical rules that express possible policies to be interpreted by policy component 42 of FIG. 5. FIG. 7 shows three rules. The first rule is triggered by an IDLE-to-BUSY state transition, state transition 55 of FIG. 6. The policy expressed by this rule causes two actions to be taken. The first, SUSPEND, is a directive to the guest OS scheduler to cause all processes implementing the current grid workload to be stopped. The second, NOTIFY, causes the policy component 42 of FIG. 5 to send an appropriate message to the global grid manager via communication to global grid manager component 43. The message notifies the global grid manager that the interactive workstation 1 of FIG. 5 is not available to run grid computations.

The second rule of FIG. 7 is triggered by an AVG.-to-IDLE state transition, state transition 53 of FIG. 6. The policy expressed by this rule causes one action to be taken, that of causing the policy component 42 of FIG. 5 to send an appropriate message to the global grid manager via communication to global grid manager component 43. The message notifies the global grid manager that the interactive workstation 1 of FIG. 5 is available to run grid computations.

The third rule of FIG. 7 is triggered by an IDLE-to-AVG. state transition, state transition 53 of FIG. 6. The policy expressed by this rule causes one action to be taken, that of causing the policy component 42 to send a directive to the host OS 4 scheduler to cause all processes implementing the hypervisor application 10 to be run at a reduced priority level. This directive is sent using communications to host agent component 44, as previously described in FIG. 4a.

In FIG. 5, a situation may arise that communication component 43 receives direction from the global grid manager. An example of this direction is a command to suspend the processing of grid workload 30, as has been previously described in the description of the first rule of FIG. 7. A second example is a command from the global grid manager to checkpoint the state of virtual machine 12. This requires a communication path to hypervisor application 10, which may be implemented by introducing another communications component analogous to communications component to host agent 44. This new communications component communicates with hypervisor application 10 to pass directives that, for example, cause hypervisor application 10 to suspend processing in virtual machine 12 and write the state of virtual machine 12 to a file. This function is called “checkpointing,” and the VMWare workstation application listed earlier has this function, although not supported by an API. Checkpointing should be preceeded by suspending the processing of the grid workload, as previously described.

Once a checkpoint has been accomplished the virtual machine can be resumed to allow subsequent communication to the global grid manager via communication component 43. An additional command from the global grid manager can be defined to export or import a checkpoint. As previously described, the communications component to hypervisor application 10 can direct the hypervisor application 10 to read or write the checkpoint. In this way a given grid workload 30 can be suspended, virtual machine 31 checkpointed, and the checkpoint exported to the global grid manager. Subsequently the global grid manager can import the checkpoint to a different interactive workstation, thus permitting the grid workload to be moved from one interactive workstation to another. This action may be desirable if it is determined that, for example, interactive workstation 1 is likely to be in the BUSY state 52 of FIG. 6 for a lengthy period of time, and the organization originating the grid workload wishes it to be completed in a timely manner.

### EXAMPLE

An example of the present invention illustrating its operation is set forth hereinafter. As noted above, in an enterprise, at any given time there are many unused desktop resources that can be harnessed to form an enterprise scale grid. One difficulty is that each desktop user may want to set his/her own policies that decide when a desktop can and cannot participate in a grid computation. The policies may vary from desktop to desktop and so too can the conditions that affect a policy. Thus, to form a desktop based grid, many conditions and policies need to be evaluated simultaneously.

The system exemplified herein consists of a monitoring component and a policy based decision making component. An instance of each component runs on a participating desktop. The monitoring component provides interfaces through which specialized monitoring modules can be plugged in. Through these specialized modules, pertinent resource attributes can be probed for their state and individual samples or aggregated data can be gathered by the monitoring component. This information is made available to the policy component. The policy component allows each desktop user to set his/her own policy describing the conditions under which the desktop can participate in grid computations. Importantly, the policy component also allows incorporation of modules to evaluate current conditions and to predict about conditions in the future. Current conditions and historical trends are obtained from the monitoring component. The current and the predicted conditions are evaluated against the set policies to determine if the desktop resources can participate in the grid computations. The decision may affect current participation and/or participation at a future time.

In using an embodiment of the present invention, the user set policy allows the desktop to participate in grid computations only when local workload results in a CPU utilization less than, for example, 20%. A module sampling the CPU utilization is plugged in into the monitoring component and the CPU utilization is tracked and aggregated over multiple time intervals (e.g., past 1 minute, 5 minutes, 15 minutes, etc.}. A time series analyzer is plugged into the policy component. The time series analyzer reads in the CPU utilization data and makes predictions about future CPU utilization (e.g., CPU utilization 1 minute from now, 5 minutes from now, and so on}. The analyzer implements the following algorithm: if the average CPU utilization is less than 5% (considered to be the idle state) over previous t period of time, then it will continue to be in that state for the next t amount of time.

If the utilization is less than about, for example, 20% (average utilization} over the last t amount of time, then it will continue to be in that state with probability P(1-u} and it will transit to busy state (greater than 20% utilization} with probability P(u). Similar state transition assumptions are made about the busy state. As noted above, FIG. 6 illustrates the state transition diagram used by the algorithm implemented in the time series analyzer.

Using this algorithm, the CPU utilization is predicted for a future time interval. The methodology for predicting such utilization is discussed in detail in co-pending application Ser. No. ______ filed concurrently and entitled “Policy-Based Hierarchical Management of Shared Resources in a Grid Environment.”

The invention as described above must be viewed in its totality. The invention uses the hypervision based virtual machines to run grid workload and controlling that workload according to externally defined policies. These externally defined policies effectively define how the resources of the desktop system are to be allocated between interactive workload and grid workload. Both types of workload vary over time and so enforcement of policies requires continuous monitoring and taking actions based upon current as well as anticipated events.

It can be seen that the description given above provides a simple, but complete implementation of a system that allows grid computations on an interactive workstation, safeguarding both grid and interactive computations, and the responsiveness of the workstation for interactive use. Means have been described for temporarily suspending or re-prioritizing grid computations when an interactive computation must be performed. Means have been described for migrating grid computations when the grid computation must be completed in a timely manner and the interactive workstation that it has been assigned to has become busy with an interactive workload.

Although the invention has been described for a single interactive workstation, this is not limitation of the invention. It can be applied to multiple interactive workstations as well. Centralized grid managers are not required, as a similar function can be performed through peer consensus. The host operating system of the interactive workstation need not be one of the Windows family of operating systems, but can be any operating system for an interactive workstation. The interactive workstations 1 and 2 of FIG. 1 and the server computer 3 need not be on a single computer network but may be on separate computer networks, provided that communication between all computer networks is possible. The hypervisor application need not be VMWare Workstation; other hypervisor applications, such as Connectix Virtual PC for Windows are usable as well.

1. A system for enabling a guest virtual machine in a windows environment for policy-based participation in grid computations comprising:
a plurality of interactive workstations attached to and adapted to communicate to a computer network;
each said workstation comprising;
a host operating system supporting both interactive applications and hypervisor applications;
said hypervisor applications support a virtual machine;
and each said virtual machine possesses a guest operating system which supports grid applications; and
said workstation also contains a host-agent component and said virtual machine contains in addition a grid workload component and a policy-based decision-making component;
a server computer comprising:
an operating system;
grid management software;
said server computer being connected to said computer network and capable of communicating to it; wherein,
said interactive workstations communicate with said server computer via said computer network;

2. The system defined in claim 1 wherein said host operating systems and said computer server contain communications function permitting applications allowing said host operating system and said server computer to communicate.

3. The system defined in claim 1 wherein said guest operation systems and said computer server contain communications function permitting applications allowing said guest operating system and said server computer to communicate.

4. The system defined in claim 1 which contains means by which said grid applications can communicate with said grid management software.

5. The system defined in claim 2 wherein said host agent is an application program using functions and facilities of said host operating system, and said grid workload and policy-based decision-making components are application programs using functions and facilities possessed by said guest operating system.

6. The system defined in claim 3 wherein said guest operating system, said workload and policy-based decision making component run in said virtual machine, which virtual machine is supported by said hypervisor application.

7. The system defined in claim 6 wherein said guest operating system and said host operating system contain communications means permitting applications using said guest operating system and said host operating system to communicate.

8. The system defined in claim 7 wherein communication means enable said policy-based decision-making component to communicate with said host agent.

9. The system defined in claim 8 wherein said host agent uses functions and facilities possessed by said host operating system to obtain information concerning the current state of a resource utilization of all software components supported by said host operating system, and as a result of said host agent's ability to communicate with said policy-based decision-making component, said host agent transmits said resource utilization of all software components supported by said host operating system to said policy-based decision-making component.

10. The system defined in claim 9 wherein said policy-based decision-making component analyzes aid current state of a resource utilization of all software components supported by said host operating system and using analyzing means produces a model of resource utilization within said system.

11. The system defined in claim 10 wherein said model of resource utilization within said system is utilized in any subsequent resource allocation decisions.

12. The system defined in claim 11 wherein said host agent obtains a current state of said resource utilization of all software components within the system using means for application programming interface supported by means for operating systems for interactive workstations.

13. The system defined in claim 12 wherein said host agent is restricted to monitoring functions and said analyzing functions are performed by said policy-based decision-making component.

14. The system defined in claim 13 wherein said interactive workstations optionally support multiple hypervisor applications permitting its membership in multiple grids or support multiple said virtual machines permitting membership in multiple grids.

15. The system defined in claim 14 wherein said host agent comprises a WMI interface, monitoring framework, at least one monitoring plug-in and inter-communication software.

16. The system defined in claim 15 wherein said inter-communication software provides means to simplify implementation of monitoring said plug-ins by providing the communications functions as needed by said plug-ins.

17. The system defined in claim 16 wherein said monitoring framework provides means, together with said means for application programming interface supported by means for operating systems for interactive workstations, to simplify implementation of said monitoring plug-ins by providing only those functions required to retrieve resource utilization information from said means for application programming interface supported by means for operating systems for interactive workstations, and by providing functions supporting the downloading of new monitoring plug-ins, registering said plug-ins with a monitoring framework, and activating and de-activating said plug-ins.

18. The system defined in claim 17 wherein said monitoring plug-ins are downloaded via said inter-component communications software.

19. The system defined in claim 18 wherein commands are sent from said policy-based decision-making component to said monitoring framework to cause said monitoring framework to download plug-ins using functions and facilities of said host operating system.

20. The system defined in claim 19 wherein said policy-based decision-making component comprises a workstation model, a time series analysis element, a policy component element, a communication to global grid manager component and a communication component to said host agent.

21. The system defined in claim 20 where said time series analysis element receives samples of resource utilization via said communications component to said host agent and said time series analysis element, and said time series analysis element performs statistical analyses of a sequence of samples so as to eliminate short-term variations and identify longer-term variations.

22. The system defined in claim 5 wherein said system, in said interactive workstation, has a first state transition representing onset or ceasing of an interactive workload;
a second state transition representing onset or ceasing of a burst of substantial interactive activity; or
a third state transition represents a ceasing or resumption of interactive activity; and has
software responsive to said state transitions which reacts according to policies set by either a user of said interactive workstation or by administrators of said interactive workstation, or both.

23. The system defined in claim 22 wherein said policy component is implemented as a rules-driven engine.

24. A system for enabling a guest virtual machine in a windows environment for policy-based participation in grid computations, comprising articles of manufacture which comprise computer-usable medium having computer-readable program code means embodied therein for enabling said guest virtual machine in a windows environment for policy-based participation in grid computations:
said computer readable program code means in a first article of manufacture comprising a host operating system having readable program code means for causing a computer to manage workstation resources comprising memory, disk storage and processor time and said wherein code means provides an application programming interface (API) for applications to request and use said resources;
said computer readable program code means in a second article of manufacture comprising a host operating system having readable program code means for causing said computer to manage a host-agent which monitors usage of said workstation resources using host operating system APIs; and said code enables communication of data to a policy-based decision-making component;
said computer readable program code means in a third article of manufacture comprising a hypervision application system having readable program code means for causing a computer to use said host operating system APIs and for providing an emulation of the resources of said workstation, at a level of the instruction set of said workstation processor;
said computer readable program code means in a fourth article of manufacture comprising a virtual machine system having readable program code means for causing a computer to emulate the resources of workstation as provided by said hypervisor application;
said computer readable program code means in a fifth article of manufacture comprising a guest operating system having readable program code means for causing a computer to run in said virtual machine, to manage said emulated resources provided by said virtual machine and to provide an API;
said computer readable program code means in a sixth article of manufacture comprising a policy-based decision making component system having readable program code means for causing a computer to receive data from said host agent; for analyzing said data;
determining from said data which of several states of said interactive usage workstation it is currently in; obeying predetermined rules of policy to be applied as said workstation transits between states of interactive usage; communicating changes in said workstation availability for grid computation to grid management software.
said computer readable program code means in a seventh article of manufacture comprising a grid workload component system having readable program code means for causing a computer to perform non-interactive grid computations sharing the resources of said workstation; said grid computations to be done at the request of users other than the interactive user of said workstation;
said computer readable program code means in an eighth article of manufacture comprising a server system component containing operating system having readable program code means for causing a computer to whose purpose is to manage server computer resource, including memory, disk storage and processor time functions and to provide an APT for applications to request and use said resources,
said computer readable program code means in a ninth article of manufacture comprising a grid management software system containing an application program having readable program code means for causing a computer to use said APIs of said operating system, for the purpose of managing said resources represented by said virtual machines on behalf of grid computation users.

25. An article of manufacture as recited in claim 24, the computer readable program code means in said article of manufacture further comprising computer readable program code means in a WMI interface, the function of said code being to abstract functions and facilities of said WMI subset of a Windows operating system APIs, to make them convenient for use and to isolate users from the effects of versions and maintenance.

26. An article of manufacture as recited in claim 25, the computer readable program code means in said article of manufacture further comprising computer readable program code means in a Monitoring framework component, the function of said code being to capture data from said WMI interface and to support a software environment suitable for monitoring plug-ins, including downloading and installation of said plug-ins.

27. An article of manufacture as recited in claim 26, the computer readable program code means in said article of manufacture further comprising computer readable program code means in a Monitoring plug-in, the function of said code being to capture specific data from said monitoring framework and to perform preliminary processing on such data.

28. An article of manufacture as recited in claim 27, the computer readable program code means in said article of manufacture further comprising computer readable program code means in a Host agent to Policy-based decision-making component communications, the function of said code being to simplify communications between said plug-ins and said Policy-based decision-making component.

29. An article of manufacture as recited in claim 28, the computer readable program code means in said article of manufacture further comprising computer readable program code means in a Communications to host agent component, the function of said code being to simplify communications between a time series analysis component and said host agent using said APIs of said guest-operating system.

30. An article of manufacture as recited in claim 29, the computer readable program code means in said article of manufacture further comprising computer readable program code means in a Time series analysis component, the function of said code being to process data received from said host agent to determine trends in said data.

31. An article of manufacture as recited in claim 30, the computer readable program code means in said article of manufacture further comprising computer readable program code means in a Workstation model, the function of said code being to use data received from time series analysis component to update a model of the availability of said workstation resources for grid computation.

32. An article of manufacture as recited in claim 31, the computer readable program code means in said article of manufacture further comprising computer readable program code means in a Policy component, the function of said code being to react to changes in the state of said workstation model according to a set of policies, some of which may specify control actions to said host operating system or informatory notifications to grid management software.

33. An article of manufacture as recited in claim 32, the computer readable program code means in said article of manufacture further comprising computer readable program code means in a Communication to a global grid manager component, the function of code being to simplify communication between said policy component and said grid management software.

34. A method for enabling a guest virtual machine in a windows environment for policy-based participation in grid computations using the system defined in claim 1, comprising: an interactive workstation having computer-usable medium software therein, said software that runs on said interactive workstation comprises two components comprising a host-agent component, which runs as an application on said host operating system, and a second component which is a policy-based decision-making component, which runs on a guest operating system in a virtual machine;
said host-agent monitors the usage of the resources of said workstation, categorizing that usage into interactive use and grid computation usage;
said host-agent communicates a sequence of usage measurements to said policy-based decision-making component, which does a time series analysis of the usage measurements;
said time series analysis is used to update a model of the resource availability of the workstation for grid computations;
said model is used to determine the suitability of the workstation for future grid computations, and whether to defer any current grid computations to prevent a reduction in the interactive responsiveness of said workstation;
based upon said determinations of said model, if it is determined that the workstation is currently being used interactively, or if it is determined that it is likely to be used interactively in the near future, a remote grid manager is notified;
said grid manager as a result of said determinations will then not allocate any new grid computations to that workstation;
and if said workstation is currently performing grid computation and interactive use commences, said grid computation will be run at low priority until it can be checkpointed and either deferred or migrated to another virtual machine in another workstation.
